(19) United States
(12) Patent Application Publication
(10) Pub. No.: US 2008/0282338 A1
(43) Pub. Date: Nov. 13, 2008

(54) SYSTEM AND METHOD FOR PREVENTING THE RECEPTION AND TRANSMISSION OF MALICIOUS OR OBJECTIONABLE CONTENT TRANSMITTED THROUGH A NETWORK

(76) Inventor: KEVIN J. BEER, POWELL, OH (US)

Correspondence Address: ELEY LAW FIRM CO., 7870 OLENTANGY RIVER RD, SUITE 311, COLUMBUS, OH, 43235, US

(21) Appl. No.: 12/117,847

(22) Filed: May 9, 2008

Related U.S. Application Data
(60) Provisional application No. 60/916,984, filed on May 9, 2007.

(51) Int. Cl. G06F 12/14; H04L 9/32

(52) U.S. Cl. 726/12; 726/22

(57) ABSTRACT

A system for preventing the reception and transmission of malicious or objectionable content transmitted through a network. A thin is client installed upon a user computer and is associated with a web browser computer program installed upon the user computer, the thin client and web browser being coupled to a web proxy server with a network service provider. At least one protective server is intermediate the web proxy server and the network, the protective server being dedicated to detecting a type of malicious or objectionable content and acting to deter the reception of detected content by the user computer. At least one reference library contains a profile defining malicious or objectionable content, the protective server utilizing the library to identify the malicious or objectionable content.

This application claims priority to U.S. provisional application 60/916,984, filed May 9, 2007, the contents of which are hereby incorporated by reference.

### FIELD

The present invention relates generally to network communications, in particular to a system and method for deterring the reception of malicious or objectionable content transmitted through a network, such as the internet.

### BACKGROUND

The internet is a global system of computers that are linked together so that the various computers can communicate with one another. To accomplish this, internet users access “server” computers in order to download and display informational pages. Once a server has been connected to the internet, its informational pages can be displayed by virtually anyone having access to the internet.

While the internet can provide a tremendous amount of information about a wide variety of subjects, it can also pose dangers, especially for children. Parents want their children to have access to the many educational resources that can be found on the internet. At the same time, parents want to prevent their children from accessing the many internet “web sites” that contain violence, pornography, and other material inappropriate for children. Even more so, parents want to protect their children from child predators that use the internet as a medium to contact and lure children into online “chat room” conversations and to in-person meetings.

Conventional computer technology provides some measures that parents can take to protect their children from material and individuals that may be harmful. One type of conventional computer technology for protecting children is blocking software that blocks access to certain sites that have been predetermined as inappropriate or which contain key words, such as profanity or sex-related words. Blocking software comes in different forms, such as stand-alone software packages, resources on the internet, and as an online service that allows parents to limit access to certain sites and features, such as e-mail, instant messages, or certain content. In order to determine which sites and content are most appropriate for children, child-specific search engines, ratings, and review sites are also available. These search engines and directories yield only those sites that have been determined appropriate for children. Of course, such search engines and blocking software do not automatically protect children from all inappropriate content, especially communications between children and child predators. Accordingly, a need exists for a way to protect children from potentially dangerous communications via the internet.

The internet can also pose dangers in the business environment. Employers want their employees to have access to the many resources that can be found on the internet. At the same time, employers want to prevent their employees from accessing the many internet web sites that contain violence, pornography, and other inappropriate material. There is also a need to prevent business information such as intellectual property from being disseminated over the internet by employees without the express authority of the employer.

### SUMMARY

The present invention is a system and method for protecting a user of a network, such as the internet, from receiving malicious or objectionable content through the network. The system and method may be deployed utilizing “software as a service” (SaaS).

SaaS is a software application delivery model where a software vendor develops a web-native software application and hosts and operates (either independently or through a third-party) the application for use by its customers over the internet. Customers do not pay for owning the software itself but rather for using it. They use it through an application programming interface (API) accessible over the internet.

SaaS is generally associated with business software and is typically thought of as a low-cost way for businesses to obtain the same benefits of commercially licensed, internally operated software without the associated complexity and high initial cost. SaaS provides several advantages for situations where users of the software have little interest or capability in software deployment, but do have substantial computing needs.

Advantages of SaaS include, without limitation, (1) network-based access to, and management of, commercially available (i.e., not custom) software; (2) activities that are managed from central locations rather than at each customer's site, enabling customers to access applications remotely via the internet; (3) application delivery that typically is closer to a one-to-many model (single instance, multi-tenant architecture) than to a one-to-one model, including architecture, pricing, partnering, and management characteristics; and (4) centralized feature updating, which obviates the need for downloadable patches and upgrades.

SaaS applications may be priced on a per-user basis, sometimes with a relatively small minimum number of users, and often with additional fees for extra bandwidth and storage. SaaS revenue streams to the vendor are therefore lower initially than traditional software license fees, but are also recurring, and therefore viewed as more predictable, much like maintenance fees for licensed software.

The traditional rationale for outsourcing of information technology (IT) systems is that by applying economies of scale to the operation of applications, a service provider can offer better, cheaper, more reliable applications than companies can by themselves. The use of SaaS-based applications has grown dramatically, as reported by many of the analyst firms that cover the sector. But it is only in recent years that SaaS has truly flourished. Several important changes in the workplace have made this rapid acceptance possible. Firstly, nearly everyone has access to a computer and most information workers have access to a computer and are familiar with conventions from mouse usage to web interfaces. As a result, the learning curve for new, external applications is lower and less hand-holding by internal IT is needed.

In addition, computing itself has become a commodity. In the past, corporate mainframes were jealously guarded as strategic advantages. More recently, the applications were viewed as strategic. Today, people know it's the business processes and the data itself—customer records, workflows, and pricing information—that matters. Computing and application licenses are cost centers, and as such, they are suitable for cost reduction and outsourcing. The adoption of SaaS could also drive internet-scale to become a commodity.

Insourcing of IT systems requires expensive overhead including salaries, health care, liability and physical building space. Thus, there is a desire to minimize these expenses.

Computer applications are becoming standardized. With some notable, industry-specific exceptions, most people spend most of their time using standardized applications. An expense reporting page, an applicant screening tool, a spreadsheet, or an e-mail system are all sufficiently ubiquitous and well understood that most users can switch from one system to another easily. This is evident from the number of web-based calendaring, spreadsheet, and e-mail systems that have emerged in recent years.

Parametric applications are becoming usable. In older applications, the only way to change a workflow was to modify the code. But in more recent applications—particularly web-based ones—significantly new applications can be created from parameters and macros. This allows organizations to create many different kinds of business logic atop a common application platform. Many SaaS providers allow a wide range of customization within a basic set of functions.

A specialized software provider can now target global markets. A company that made software for human resource management at boutique hotels might once have had a hard time finding enough of a market to sell its applications. But a hosted application can instantly reach the entire market, making specialization within a vertical not only possible, but preferable. This in turn means that SaaS providers can often deliver products that meet their markets' needs more closely than traditional “shrinkwrap” vendors could.

Web systems are becoming more reliable. Despite sporadic outages and slow-downs, most people are willing to use the public internet, the Hypertext Transfer Protocol and the TCP/IP stack to deliver business functions to end users.

Security is has become sufficiently well trusted and transparent. With the broad adoption of SSL organizations have a way of reaching their applications without the complexity and burden of end-user configurations or virtual private networks (VPNs).

Organizations developing enablement technology that allow other vendors to quickly build SaaS applications will be important in driving adoption. Because of SaaS' relative infancy, many companies have either built enablement tools or platforms or are in the process of engineering enablement tools or platforms. A Saugatuck study shows that the industry will most likely converge to three or four enablers that will act as SaaS Integration Platforms (SIPs).

Wide Area Network's bandwidth has grown drastically following the Moore's Law (more than 100% increase each 24 months) and is expected to reach slow local networks bandwidths. Added to network quality of service improvement this has driven people and companies to trustfully access remote locations and applications with low latencies and acceptable speeds.

An object of the present invention is a system for preventing the reception and transmission of malicious or objectionable content transmitted through a network. A thin is client installed upon a user computer and is associated with a web browser computer program installed upon the user computer, the thin client and web browser being coupled to a web proxy server with a network service provider. At least one protective server is intermediate the web proxy server and the network, the protective server being dedicated to detecting a type of malicious or objectionable content and acting to deter the reception of detected content by the user computer. At least one reference library contains a profile defining malicious or objectionable content, the protective server utilizing the library to identify the malicious or objectionable content.

### BRIEF DESCRIPTION OF THE DRAWING

Further features of the inventive embodiments will become apparent to those skilled in the art to which the embodiments relate from reading the specification and claims with reference to the accompanying drawings, in which the single FIGURE is a flow diagram of a system and method for preventing the reception of malicious or objectionable content transmitted through a network according to an embodiment of the present invention.

### DETAILED DESCRIPTION

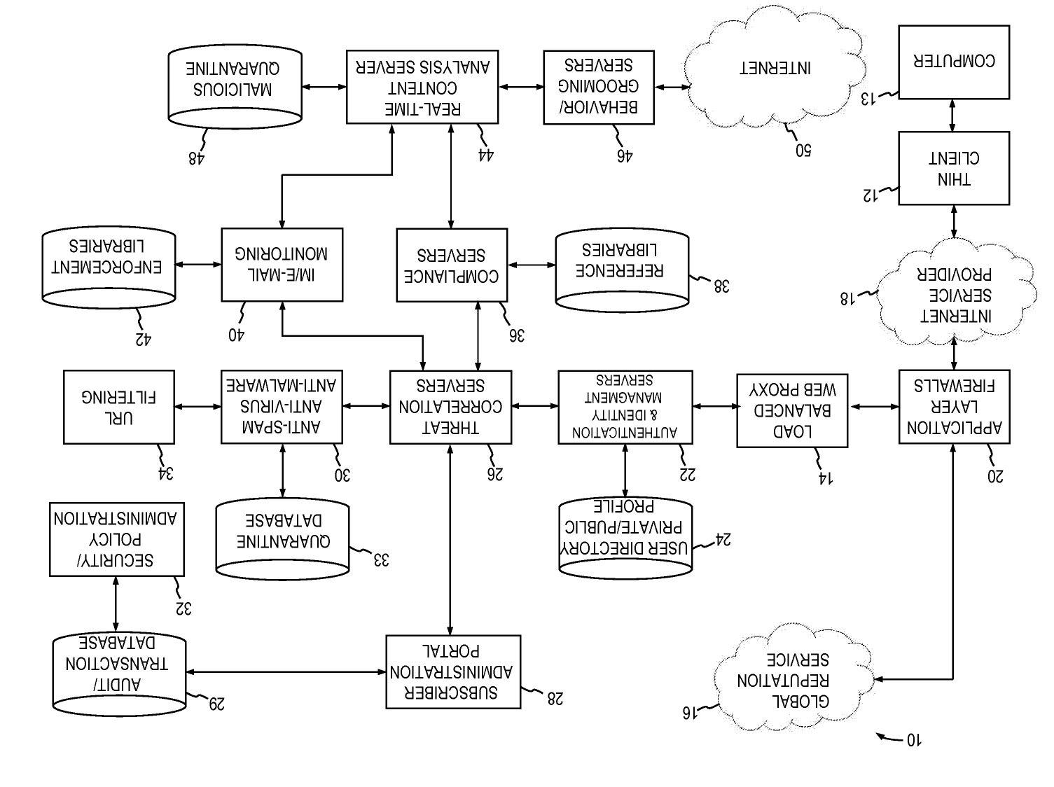

A flow diagram showing the general arrangement of a system and method 10 for preventing the reception of malicious or objectionable content transmitted through a network is shown in FIG. 1 according to an embodiment of the present invention. System and method 10 may alternatively be termed a “managed security service” and “service” in the discussion that follows.

A thin client 12 represents a software computer program utilized by a “subscriber” of a service employing system and method 10, such as a parent, with a desire to protect a “user,” such as a child having access to the internet through a computer located in the subscriber's home. The subscriber may provide a conventional desktop or portable computer 13, having a hardware and software configuration that can support service 10 and client 12 installed thereon. An example of such a computer may be one with the minimum predetermined hardware requirements, operating system version with updated patch releases, memory and internet web browser settings. Service 10 may automatically check the configuration of computer 13 before initialization of the service is activated. If the computer meets all the aforementioned configuration requirements, an installation of thin client 12 therein may begin and registration of service 10 will initiate. Accordingly, computer 13 is the only computer that may be used with service 10. Any additional computers within the home or brought into the home will not have access to managed security service 10 unless a thin client 12 is also installed therein.

Thin client 12 comprises a relatively small, unobstructed computer program that is installed and loaded onto all internet web browsers (i.e., computer programs that provide a user with the ability to use the internet) located on the subscriber's computer 13 operating system. Thin client 12 resides within the browsers and cannot be uninstalled, removed or bypassed without an administrator (i.e., the subscriber) logging into managed security service 10 and following a predetermined procedure. This procedure will remove thin client 12 from the computer and deregister the subscriber from managed security service 10. Accordingly, service 10 subsequently becomes unavailable to the subscriber and/or the users.

Once computer 13 is registered with service 10 and thin client 12 installed therein, a user cannot uninstall the thin client from the browser, use a second browser on the computer to bypass service 10, or delete/reinstall another browser to bypass the service. Once registered, managed service 10 “fingerprints” computer 13 for operating and computer-specific information such as its media access control (MAC) address and memory settings. Consequently, if a browser is deleted, or even if the computer is completely rebuilt, when the subscriber is connected to their ISP and makes an “http//:” internet address request, managed security service 10 will first require reinstallation of thin client 12, update the register, and log the process.

Thin client 12 directs the subscriber's computer 13 to retrieve information exclusively through web proxy server 14 and any associated databases maintained by service 10. Web proxy server 14 recognizes the subscriber's thin client 12 internet protocol (IP) address of computer 13, and requires completion of a predetermined authentication procedure before allowing any web content to be displayed on the computer. Web proxy server 14 works in conjunction an application layer firewall 20 and a global web reputation service 16 to recognize the user and redirect them to managed security service 10.

An internet service provider 18, which may alternatively be termed an “ISP” herein, provides internet access to the subscriber. ISP 18 may be any conventional internet service provider now known or later developed, such as cable-based, digital subscriber line (DSL), dial-up and satellite service providers.

It should be understood that ISP 18 is neutral with respect to managed security service 10. That is, ISP 18 does not control subject matter or content, and is merely a conduit for managed security service 10. Consequently, ISP 18 is not required to impede or restrict service to any http//: internet address request made from a user to the ISP, nor does the ISP restrict the initialization and registration of a new subscriber and the users thereunder.

Web proxy server 14 is essentially the gateway to managed security service 10 and its features. Server 14 is preferably of a load balancing type in order to handle a high volume of http//: internet address requests. Accordingly, web proxy server 14 may in practice comprise a plurality of servers operating cooperatively to manage internet traffic handled by service 10.

Each web proxy server 14 is a server (i.e., a computer system, appliance or application program) which services the requests of its clients (such as a web browser of computer 13 operated by a user) by forwarding the user's request to other servers. A client connects to proxy server 14, requesting some service, such as a file, connection, web page, or other resource available from a different server. The proxy server 14 provides the requested resource by connecting to the specified server and requesting the service on behalf of the client. The proxy server 16 may optionally alter the client's request or the server's response, and sometimes it may serve the request without contacting the specified server. In this case, it would cache the first request to the remote server, so it could save the information for later, thereby improving internet response time to the user (i.e., increasing traffic speed).

Once web proxy server 14 connects to the client it will make its initial request through application firewall 20 to an authentication server 22. However, once an end user is connected via the client and is successfully logged into managed security service 10 the web proxy server 14 will make the request to the appropriate servers or respond itself with the information, if available in its cache.

Web proxy server 14 provides comprehensive security for various aspects of internet web traffic. For user-initiated web requests, web proxy server 14 first enforces a predetermined internet use policy. For all allowed traffic, web proxy server 14 then provides protection against threats such as malicious software or “malware” (a computer program designed to infiltrate or damage a computer system without the owner's informed consent) that may be hidden within internet web pages by analyzing the nature and intent of the content and active code entering the network via those web pages. In-depth protection provided by web proxy server 14 may cover encrypted secure socket layer (SSL) traffic as well.

The interactive nature of internet web sites enables users to contribute content and information as well as receive it. Accordingly, web proxy server 14 scans user-transmitted content, protecting users from sending web-based threats such as hate, malicious or infectious content sent using conventional internet communication protocols (such as HTTP, HTTPS, and FTP), as well as protocols later invented. Such content may be transmitted by the user through “blogs” (web commentary), “wiki” (user-contributed web pages) and even online productivity tools such as organizers and calendars, among others.

Application layer firewall 20, interchangeably termed “unified threat management” (UTM) herein, consolidates perimeter security functions into a single system. Application layer firewall 20 serves as a network gateway security appliance for managed security service 10. UTM 20 is preferably a robust, self-defending perimeter firewall for managing security. For example, UTM 20 may include a combination of high-speed application proxies, reputation-based global intelligence 16, and signature-based security services. With such elements application firewall 20 is able to defend networks and internet-facing applications from various types of malicious threats, both known and unknown. This is desirable to secure access to managed security service 10 and to protect users thereof from malicious attackers, as well as to monitor and manage the use of the internet, kill hidden attacks in packet streams, block viruses and spyware in file transfers, and create a forensic-quality audit trail for subscribers (such as parents), law enforcement personnel and other reporting aspects of the service.

In structuring UTM 20 several security models may be utilized. As a first example, a negative security model may identify bits of traffic already known to be threatening. Anti-virus and intrusion detection/prevention systems are classic examples of this approach, which both depend upon checking traffic flows against known attack signatures. With threats increasing at a rapid pace, this results in less and less time to react to new attacks, and a steady increase of successful attacks over time may result.

A second example security model is a positive security model, which understands and allows only legitimate, acceptable traffic elements and denies everything else. Current estimates indicate that about 70% of all new malware is focused on application-oriented vulnerabilities, and network-layer firewalls are typically not designed to securely protect against this method of delivering attacks. Another benefit to the positive security model is geographic filtering or “geo-filters.” This provides policies to be enforced that will not allow any connection or communication to the user from specific countries. For example, if a subscriber wishes to restrict communications to within the user's home country, this restriction may be enforced as a policy and no connection will be accepted from outside the home country. In the future this type of restriction may be even more narrowly controlled, such as to communications within predetermined states and local communities. These models are presented as examples of security models for UTM 20 and are not intended to be limiting. Any security model now known or later invented may be utilized.

Application-specific proxies, including filtering for e-mail (electronic mail), web, VoIP (voice over internet protocol), and other conventional high-use internet protocols. Each proxy may be configured according to the subscriber's/users' unique use, which forms a baseline against which all traffic is checked. These intelligent application-specific filters may enable a user to tightly define only the allowed use of these applications (on a per-rule basis) and then pass only the allowed traffic through at gigabit speeds. Application proxies provide a high level of security while still supporting high-speed communication.

UTM 20 may include global reputation based reputation service 16, which in turn may incorporate a bi-directional global intelligence feed from predetermined data centers (not shown). Reputation service 16 enables UTM 20 to make proactive security decisions based on the real-time known threat behavior of internet traffic, i.e. IP addresses, domain names, phishing sites (i.e., internet sites that attempt to fraudulently acquire personal information from unsuspecting users) and e-mail messages. In operation, a conventional domain name system (DNS) call is made once an http//: internet address request is made to the end user's e-mail account, instant messaging (IM), chat room (internet-based social communication environments), or application. If the sender has a negative reputation according to reputation service 16, then the connection is dropped before the end user knows a request was made.

Reputation service 16 may typically analyze over 100 billion e-mail messages worldwide each month and continually assign each IP sender a numeric reputation score ranging from good to bad. This dynamic scoring system provides UTM 20 with a tool for comprehensive protection.

Authentication server 22 provides authentication services to users and to other systems. For example, users and other servers may authenticate server 22 and receive cryptographic tickets. These tickets are then exchanged with one another to verify identity. Authentication is used as a basis for authorization (i.e., determining whether a privilege will be granted to a particular user or process), privacy (keeping information from becoming known to non-participants), and non-repudiation (not being able to deny having done something that was authorized to be done based on the authentication).

A user directory or database 24 associated with an authentication server 22 stores the end user's profile and an authentication ticket that has a fingerprint of the computer 13 that is registered with managed security service 10. This directory also stores the profile of the end user. If the end user is under 18 years of age (as determined in the profile) then the profile may be designated as a private profile. With a private profile, end user privacy is enforced under subscriber (i.e., parental) restrictions. An example of enforced privacy would be: (1) all users over 18 years of age are blocked from contacting end users under 18 years of age; (2) all users under 18 years of age are blocked from all sexually based and adult social rooms or adult social web sites, including classifieds and casting calls; (3) all users over 18 years of age cannot add users under 18 years of age to social web sites unless the parent approves (i.e., “white lists”) the over-18 user as family or otherwise trustworthy; (4) all users must have a registered e-mail address and first/last name with managed security service 10 to request and register an end user as a friend; and (5) all images that are uploaded will be scanned by service 10 for sexual or malicious content. Users who post adult content through service 10 may be excluded from internet access and their IP address may all be given to local law enforcement and appropriate agencies, such as the National Center for Missing and Exploited Children (NCMEC).

Authentication server 22 may additionally utilize federated identity management (i.e., managing identities across plural security domains) provided by directory 24 to authenticate and check against any universal resource locator (URL) internet address to verify that it is a user (i.e., child) friendly web site. Federated identity management techniques often use security assertion markup language (SAML) technology and a conventional web services security communications protocol such as WS-Security as standards to enforce trust to other web sites.

Stronger authentication procedures may be applied as an option for subscribers (such as parents) who desire another layer of security for users (such as children). Such robust authentication procedures may utilize soft tokens (i.e., an electronic security device used to give authorized users access to secure locations or computer systems) or public key infrastructure (PKI) technologies to enforce stronger authentication rules. PKI arrangements enable computer users without prior contact to be authenticated to each other, and to use the public key information in their public key certificates to encrypt messages to each other.

A threat correlation server 26 provides a simple, at-a-glance interface to facilitate vulnerability assessment and remediation within service 10. Using threat correlation server 26, administrators of service 10 are able to quickly understand and proactively respond to the global security threats facing users. Threat correlation server 26 analyzes all the security policies and systems in place, and thus provides a common assessment of vulnerability, risk and process the end user is experiencing while using managed security service 10. Threat correlation and centralized management of the combining solutions provide a simple way for subscribers (i.e., parents) to view a log file of users' (i.e., children's) chat session and internet web sites visited, as well as communication of IM and e-mail and their recipients. It may also optionally identify any threat or security gaps that the user has within their systems.

Subscriber administration portal 28 provides a way for a subscriber to view log files 29 of chat room sessions, IM, E-mail, internet web sites visited and any attempted communication or actions by a user of system 10. Portal 28 also provides the ability for subscribers to change or administer any policies 32 that they want enforced or managed with regard to users' internet use. Subscribers can access portal 28 at any time, get alerts to behaviors and or get weekly reports emailed to their registered e-mail address.

In addition to managing potential malicious behavior and predator actions being requested by unknown users or services, service 10 includes anti-spam, anti-virus, anti-malware and URL internet address filtering protection components 30. Further description of these components is provided below.

Anti-spam components prevent unsolicited bulk e-mail, commonly referred to as “spam.” Both end users and administrators of e-mail systems may use various anti-spam techniques. Some of these techniques may be embedded in products, services and software to ease the burden on users and administrators. No one technique is a complete solution to eliminating spam, and each has trade-offs between incorrectly rejecting legitimate e-mail versus not rejecting all spam, and the associated costs in time and effort. Anti-spam techniques can be broken into four broad categories: those that require actions by individuals, those that can be automated by the e-mail administrator, those that can be automated by e-mail senders and those employed by researchers and law enforcement officials.

Anti-virus components are computer programs that attempt to identify, neutralize or eliminate malicious software. Anti-virus is so named because the earliest examples were designed exclusively to combat computer viruses; however most modern antivirus software is now designed to combat a wide range of threats, including worms, phishing attacks, root kits, “Trojan horses” (i.e., viruses hidden within legitimate computer programs) and other malware known in the art.

Quarantine database 33 stores information relating to known spam, virus and malware threats. Quarantine database 33 may include definitions used by protection components 30 to detect threats. In addition, quarantine database 33 may contain any threats identified by protection components 30, thereby isolating the threat until it is removed by service 10 or the subscriber. The definitions in quarantine database 33 may be updated regularly or as-needed by service 10 in order to identify and deter newly-developed threats.

Anti-malware components inspect all incoming and outgoing traffic. Anti-malware can easily be augmented by adding additional layers of protection that simply control the connections that are “allowed” at the gateway. Anti-malware components check for behavior activity that is malicious and not detected by signature based anti-virus or anti-spam components.

URL internet address filtering 34 provides internet access management that give subscribers the ability to enforce their internet usage policies with several flexible options. URL filter components ensure that the internet is being used productively and safely by setting policy to enforce what category of web sites are allowed and which should be “black-listed” (i.e., disallowed) and thus prevented from being accessed.

A compliance server 36 includes libraries 38 of specific regulations and policies to enforce protection of a user's internet access. The compliance server 36 is inline with any “http//:” internet address request and checks for violations of specific details of known violations such as but not limited to the Children's Internet Protection Act (CIPA), a set of federal regulations enacted in the United States in 2000. CIPA provides for filtering or blocking of offensive internet sites and is commonly used by schools and public libraries in connection with internet access at their facilities. Compliance server 36 scans for CIPA violations as well as personally identifiable information (PII) and content being sent or requested by the user. The libraries 38 are maintained and updated as needed, and are utilized by compliance servers 36 to scan for information that violates these policies. Other example policies selectable for scrutiny may include vulgarity, hate and sexually-oriented content.

One or more instant messaging and e-mail monitoring server 40 monitors, filters and blocks vulgar, sexual, predator and malicious content from instant messaging, chat room and e-mail communications. For chat rooms and instant messaging, server 40 monitors and logs both sides of instant messages. Server 40 may utilize parental controls, chat scheduling, chat-acronym translators and content monitoring libraries 42. During an IM or chat room session, once a violation is detected based on the policies set forth in the parental and law enforcement libraries 42, the session will terminate and the content logged by server 40 for forensic, law enforcement or parental reporting. None of the offensive content will be viewable to the user; likewise, the user cannot type any specific content that violates the policies in libraries 42. Subscriber controls are provided that may allow certain users under the subscription to by-pass the IM or chat room sessions for specific users with IM or E-mail address. This is accomplished by approving or “white-listing” these users as a family or friendly user that can be trusted.

If a policy violation occurs, managed security service 10 may trace the violator(s) and report one or more of their IP address, geographic location or internet traffic trace routing to appropriate third parties. With regard to e-mail, compliance server 36 monitors and prevent malicious, sexual, hate or CIPA content from being received in the end user's inbox. This includes e-mail programs installed on the computer, such as Microsoft Outlook®, that receives e-mail from messaging senders. System 10 also blocks spam, viruses and malware from entering into the e-mail account. For internet website-based (web mail) services such as Gmail, Yahoo Mail and so on the content will be blocked once a violation occurs. Consequently, if an e-mail from Yahoo Mail is opened, for example, and the content violates the policies in internet policies specified in enforcement libraries 42, then the subscriber will be notified and a justification will be displayed on the user's monitor screen. The session will not terminate, but will direct the end user to delete any web mail content from its web e-mail service.

The e-mail security components of server 40 uses contextual analysis to consider how words appear in relation to one another and minimize the risk of false positives. This analysis is performed on both the text contained in the message as well as any attachments. For example, the analysis may look for specific information, such as social security numbers, credit card numbers, street addresses and other personal information that a subscriber (i.e., a parent) would like to block a user (i.e., a child) from communicating over the internet.

Optional services provided by server 40 may include handling the end user's web mail account and encryption of sensitive material that is to be shared, yet must be secured. These services may be established upon registration and controlled by the subscriber.

All content that is requested or sent by a user that violates policies established by libraries 38, 42 will be blocked and logged for reporting to the subscriber through threat correlation server 26 and subscriber administration portal 28. An on-screen notification and justification may also be sent to the subscriber when a policy violation is detected, alerting them of the policy and the content of the violation. As an option, for example, a parent may choose to have an agent (i.e., a computer software program) initialized on the computer to scan the computer for any violations. This can be accomplished at the time of registration or periodically on a per-request basis. The agent will scan the computer's hard drive for any content that violates the managed security service compliance 10 server 36 policies of libraries 38, 42.

One or more real-time content analysis servers 44 provide a bi-directional analysis of an http//: internet address request and response from the end user to its recipients. The content is analyzed from specific information that is detected from the policies and libraries collected in the managed security service 10. This is a layer of monitoring that looks for the initial communication request from any user on the internet to the registered subscriber. The end user under the subscription may never see any communication if the content breaks any of the policies set forth within libraries 38, 42.

One or more real time content analysis servers 44 examine all content types including audio, multi media and web cam or video sessions. Accordingly, server 44 scans incoming and outgoing web content in the various internet protocols, such as HTTP, HTTPS and FTP, and analyzes it in real time regardless of its originating URL and without signature matching. Servers 44 may thus detect and block cyber crime, targeted attacks, and predator behavior and other malicious web content, also when hiding in SSL traffic. Such an active real-time code analysis approach is highly effective in handling unknown, dynamic and rich web content that cannot be detected by reactive signature- and database-reliant security technologies, as well as traditional threats.

Behavioral and anti-grooming server 46 functions as an abuse-detection system that keeps users safe without unnecessarily impeding the user's freedom of using the internet Server 46 monitors for predetermined patterns and behavior of online “groomers.” Grooming is a tactic used by online predators to win users' confidence. Such tactics are often ingenious and manipulative in their attempts to contact certain individuals, such as children, and win their confidence. For example, predators often mimic the language and attitudes of young people and display appealing tendencies with accuracy. They pretend to be friends or offer sympathy or flattery, often claiming to be the same age and sex as the potential victim or to have similar interests. These are patterns and behavioral attempts to lure susceptible users such as children into chat rooms and other activities that are malicious. To guard against this type of activity, grooming server 46 monitors internet traffic to the user from others, what is communicated in the traffic, how it is stated, and how the conversation is being steered. Server 46 may generate alerts and/or disconnect a session if the behavioral content is in violation of predetermined policies. For example, a subscribing parent may view a log file of recorded behavior and counsel a child user regarding these attempts.

A malicious and predator quarantine database 48 stores information relating to violators and profiles, to be shared with authorities. For example, any and all communication that is violated in any of managed security service 10 policies may be shared with appropriate law enforcement agencies. Such information may be categorized by malicious, predator, hate, or cyber criminal, as an example.

The internet 50 is a global system of computers that are linked together so that the various computers can communicate with one another. To accomplish this, internet users access server computers in order to download and display informational pages. Once a server has been connected to the internet, its informational pages can be displayed by virtually anyone having access to the internet.

### I. Protection of Children

In one embodiment of the present invention system and method 10 may be utilized by parent subscribers to protect their children, who are the users of the system and method while utilizing the internet through a home computer 13. Operation of this embodiment is detailed in the following paragraphs.

System and method 10 provides a way for a family to protect their home computer from malicious, predator and other unacceptable behavioral activity while utilizing the internet System and method 10 provides several layers of security for web, instant messaging, chat room and e-mail use at home, and delivered as a service model (i.e., software as a service or SaaS). This service model implements, maintains, manages and supports the software, configuration, infrastructure, policies and operation for its subscribers.

The operational process for each of the subscribed users in this embodiment of the present invention begins with a thin client 12 installed on a computer 13, which is typically located in a family home. Thin client 12 locks settings of internet web browsers installed on computer 13 and re-directs the user's browser to the web proxy 14 of service 10. Web proxy 14 pulls the user's browser to establish a connection that will allow the browser to authenticate to authentication server 22 via firewall 20. The user's browser will not be capable of executing any “http//:” internet address request until a valid authentication is successful to a registered and active subscriber.

A subscriber, such as a parent, may register and sign up for service 10, with each user under the subscription (i.e., family members) having a profile. For children under the age of 18 the profiles are preferably maintained as a private profiles, while the profiles of adult users under the subscription may be public. The profiles of each user may be stored in directory 24 as a group, as or individual users registered for computer 13. Once the registration profiles are established a parental user may select desired policies and limitations 32 for internet services such as web, instant messaging, chat room and e-mail. The parental user may complete registration for service 10 with a subscription fee, receiving in turn subscriber access with a user name and password for each user under the subscription. The user name and password must be presented to service 10 when accessing the internet Directory 24 may also utilize conventional security techniques such a “single sign on” and federated identity management, along with “fingerprinting” computer 13 for specific computer settings and computer information, in the manner previously described.

Once a user successfully authenticates to authentication server 22 the service 10 is operational. Examples of the operation of service 10 is provided in the following paragraphs, using several scenarios. The examples are provided merely to aid the reader in understanding the operation of this embodiment of service 10 and are not intended to be limiting.

### A. Web Browsing by Children

A computer 13 is configured for use with service 10 by a parental subscriber, in the manner previously discussed. If a user under the age of 18 (“child user”) desires to use computer 13 to connect to ISP 18, the child user will launch a web browser computer program on the computer. In response, thin client 12 and web proxy 14 direct the child user to authentication server 22 via firewall 20, and a successful login is accomplished. The child user will see his or her browser “home page” appear, the home page being set by the child user in the browser's settings. When the child user enters a “http//:” internet address request within the browser the request is sent through service 10 and URL filter 34 checks the request for any policy violations.

If there is no violation in the internet address request, service 10 then checks at 30 for malware, spam and viruses in the content of the request. In addition, service 10 checks the reputation of the requested site using global reputation service 16. If the content is found to be free of policy violations the content of the web site is displayed on the child user's browser. However, if the “http//:” internet address request violates a policy setting in the URL filter 34; the child user may receive a message indicating the violation, and may further receive an explanation.

If the content of the “http//:” internet address request includes malicious content (i.e., malware, viruses, Trojans, spam or phishing) the anti-malware, anti-spam, anti-virus service 30 combined with global reputation service 16 will detect and quarantine the content request in quarantine database 33. The end user may receive a display message indicating the violation, and may further receive an explanation.

If the “http//:” internet address request violates any reference library policy 38 (such as CIPA or sexually-oriented content) the request is terminated. The child user may receive a display message indicating the violation, and may further receive an explanation.

If the “http//:” internet address request has any correlation with known threats, attacks or malicious code, threat correlation server 26 will terminate the request. The child user may receive a display message indicating the violation, and may further receive an explanation.

### B. Instant Messaging and Chat Room Security

If a child user desires to use computer 13 to connect to ISP 18, the child user will launch a web browser computer program on the computer. In response, thin client 12 and web proxies 14 direct the child user to authentication server 22 via firewall 20, and a successful login is accomplished. The child user will see his or her browser “home page” appear, the home page being set by the user in the browser's settings. Once the child user begins participating in an instant message session or chat room session the session is monitored and secured for malicious content, or violation parental and law enforcement policies. The session traffic flows through IM/e-mail monitoring server 40, and real time content analysis server 44 checks the request for any policy violations and malicious content as established in enforcement libraries 42.

If there no policy violation in the bi-directional IM or chat session is detected the IM/e-mail monitoring server 40 checks using protection components 30 for any malware, spam, and viruses within the content of the request or any adverse reputation information from the global reputation service 16. If the content is not found to be objectionable the content is displayed to the child user's chat room session or IM session.

If the child user enters any content that violates any policies of enforcement libraries 42 (i.e., parental or law enforcement policies) the IM/e-mail monitoring server 40 will not display that content to the user. Reference libraries 38 also provide dictionary, numerical and translation information used to monitor content and establish policies enforce the behavior.

If a sender contacts the child user through instant messaging and transmits content that violates any parental or law enforcement policy established in enforcement libraries 42 IM/e-mail monitoring server 40 will not allow the content to be displayed to the user.

### C. E-Mail Security

If a child user desires to use computer 13 to connect to ISP 18, the child user will launch a web browser computer program on the computer. In response, thin client 12 and web proxies 14 direct the child user to authentication server 22 via firewall 20, and a successful login is accomplished. The child user will see his or her browser “home page” appear, the home page being set by the user in the browser's settings. Once the child user starts an e-mail application and creates a new e-mail the message is sent through IM/e-mail monitoring server 40. Compliance server 36 and global reputation service 16 examine the request for any policy violations and malicious content, using libraries 38, 42 respectively.

If a policy violation is not detected by compliance server 36, IM/e-mail monitoring 40 examines the message for any malware, spam or viruses within the content of the e-mail, or for any adverse reputation information from global reputation service 16. If the content is found to be without policy violations the e-mail is sent to its intended recipient.

If the child user is sent an e-mail message, the e-mail message is scanned at 30 for any malicious content, malware, spam, and viruses within the e-mail message. If the e-mail message contains any of these violations it is dropped by global reputation service 16. Alternatively, a parental user may review e-mail messages quarantined at 33, or may elect to have the quarantined e-mail deleted after a predetermined period of time has elapsed.

If the child user is sent an e-mail message and the e-mail is free of any malicious content, malware, spam and viruses, the e-mail is scanned for any policy violations from the compliance server 36. If the e-mail message violates a policy established in reference libraries 38 the e-mail message is quarantined at 33. A parental user may check quarantine 33 to review any such e-mail messages or elect to have the quarantined e-mail deleted after a predetermined period of time has elapsed.

If the child user sends an e-mail message to a recipient the e-mail message is scanned by compliance server 36 for any policy violations. If a policy established within libraries 38 is violated the e-mail is quarantined at 33. A parental user may check quarantine 33 to review any such e-mail messages or elect to have the quarantined e-mail deleted after a predetermined period of time has elapsed.

### D. Behavior and Anti-Grooming Security

If child user desires to use computer 13 to connect to ISP 18, the child user will launch a web browser computer program on the computer. In response, thin client 12 and web proxies 14 direct the child user to authentication server 22 via firewalls 20, and a successful login is accomplished. The child user will see his or her browser “home page” appear, the home page being set by the child user in the browser's settings. If the child user does not violate any policy or malicious content and no malware, spam, Trojans or viruses are found the behavioral and anti-grooming server 46 monitors for any grooming or translation behavior from any recipient or initialized communication.

### E. Parental Administration

Detected policy violations, threats, malicious content and objectionable activity the end user under the age of 18 has experienced. This activity may be viewed through subscriber administration portal 28. Reports containing the information logged at 29 may also be e-mailed to a predetermined e-mail account specified by a parental user.

### II. Internet Protection for Businesses

In another embodiment of the present invention service 10 may be utilized by employers to protect their business computers when the computers are used for internet-related activities. For example, service 10 may be configured to protect employee users from receiving malicious content, deter violations of company policies by employee users, ensure that the computers are used in compliance with applicable industry or government regulations and standards, and deter objectionable employee user behavior. System and method 10 also provides several layers of security for web, instant messaging, chat room and e-mail use at the business, and may be delivered as a service model (i.e., software as a service or SaaS). This service model implements, maintains, manages and supports the software, configuration, infrastructure, policies and operation for its subscribers.

The operational process for each of the subscribed users in this embodiment of the present invention begins with a thin client 12 installed on a computer 13, typically located in a business. Thin client 12 locks settings of internet web browsers installed on computer 13 and re-directs the user's browser to the web proxy 14 of service 10. Web proxy 14 pulls the user's browser to establish a connection that will allow the browser to authenticate to authentication server 22 via firewall 20. The user's browser will not be capable of executing any “http//:” internet address request until a valid authentication is successful to a registered and active subscriber.

A subscriber, such as a business owner or manager, may register and sign up for service 10, with each user under the subscription (i.e., the business owner or manager and their employees) having a profile which may be public. The profiles of each user may be stored in directory 24 as a group, as or individual users registered for computer 13. Once the registration profiles are established a business owner or manager may select desired policies and limitations 32 for internet services such as web, instant messaging, chat room and e-mail. The business owner or manager user may complete registration for service 10 with a subscription fee, receiving in turn subscriber access with a user name and password for each user under the subscription. The user name and password must be presented to service 10 when accessing the internet Directory 24 may also utilize conventional security techniques such a “single sign on” and federated identity management, along with “fingerprinting” computer 13 for specific computer settings and computer information, in the manner previously described.

Once a user successfully authenticates to authentication server 22 the service 10 is operational. Examples of the operation of service 10 is provided in the following paragraphs, using several scenarios. The examples are provided merely to aid the reader in understanding the operation this embodiment of service 10 and are not intended to be limiting.

### A. Web Browser Security

If an employee user desires to use computer 13 to connect to ISP 18, the employee user will launch a web browser computer program on the computer. In response, thin client 12 and web proxy 14 directs the employee user to authentication server 22 via firewall 20, and a successful login is accomplished. The employer may choose to have a SSL/VPN connection established for employers to meet certain regulations. The employee user will see his or her browser “home page” appear, the home page being set by the employee user in the browser's settings. When the employee user enters a “http//:” internet address request within the browser the request is sent through service 10 and URL filter 34 checks the request for any policy violations.

If there is no violation in the internet address request, service 10 then checks at 30 for malware, spam and viruses in the content of the request. In addition, service 10 checks the reputation of the requested site using global reputation service 16. If the content is found to be free of policy violations the content of the web site is displayed on the employee user's browser. However, if the “http//:” internet address request violates a policy setting in the URL filter 34; the employee user may receive a message indicating the violation, and may further receive an explanation.

If the content of the “http//:” internet address request includes malicious content (i.e., malware, viruses, Trojans, spam or phishing) the anti-malware, anti-spam, anti-virus service 30 combined with global reputation service 16 will detect and quarantine the content request in quarantine database 33. The employee user may receive a display message indicating the violation, and may further receive an explanation.

If the “http//:” internet address request violates any reference libraries 38 policies (such as company policies and industry or government regulations) the request is terminated. The employee user may receive a display message indicating the violation, and may further receive an explanation.

If the “http//:” internet address request has any correlation with known threats, attacks or malicious code, threat correlation server 26 will terminate the request. The employee user may receive a display message indicating the violation, and may further receive an explanation.

### B. Instant Messaging and Chat Room Security

If an employee user desires to use computer 13 to connect to ISP 18, the employee user will launch a web browser computer program on the computer. In response, thin client 12 and web proxies 14 direct the employee user to authentication server 22 via firewall 20, and a successful login is accomplished. The employer may choose to have a SSL/VPN connection established for employers to meet certain regulations. The employee user will see his or her browser “home page” appear, the home page being set by the employee user in the browser's settings. Once the user begins participating in an instant message session or chat room session the session is monitored and secured for malicious content or violation of company policies pertaining to such matters as transfer of intellectual property and industry or government regulatory compliance. The session traffic flows through IM/e-mail monitoring server 40, and real time content analysis server 44 checks the request for any policy violations and malicious content as established in enforcement libraries 42.

If no policy violation in the bi-directional IM or chat session is detected the IM/e-mail monitoring server 40 checks using protection components 30 for any malware, spam, and viruses within the content of the request or any adverse reputation information from the global reputation service 16. If the content is not found to be objectionable the content is displayed to the employee user's chat room session or IM session.

If the employee user types any content that violates any enforcement policy 42 (such as attempting to transmit company intellectual property) the IM/e-mail monitoring server 40 will not display that content to the user. Reference libraries 38 also provide dictionary, numerical and translation information used to monitor content and establish policies enforce the behavior.

If a sender contacts the employee user through instant messaging and transmits content that violates any company policy established in enforcement libraries 42 IM/e-mail monitoring server 40 will not allow the content to be displayed to the user.

### C. E-Mail Security

If an employee user desires to use computer 13 to connect to ISP 18, the employee user will launch a web browser computer program on the computer. In response, thin client 12 and web proxies 14 direct the employee user to authentication server 22 via firewall 20, and a successful login is accomplished. The employer may choose to have a SSL/VPN connection established for employers to meet certain regulations. The employee user will see his or her browser “home page” appear, the home page being set by the employee user in the browser's settings. Once the employee user starts an e-mail application and creates a new e-mail the message is sent through IM/e-mail monitoring server 40. Compliance server 36 and global reputation service 16 examine the request for any policy violations and malicious content, using libraries 38, 42 respectively.

If a policy violation is not detected by compliance server 36, IM/e-mail monitoring 40 examines the message for any malware, spam or viruses within the content of the e-mail, or for any adverse reputation information from global reputation service 16. If the content is found to be without policy violations the e-mail is sent to its intended recipient.

If the employee user is sent an e-mail message, the e-mail message is scanned at 30 for any malicious content, malware, spam, and viruses within the e-mail message. If the e-mail message contains any of these violations it is dropped by global reputation service 16. Alternatively, a business owner or manager user may review e-mail messages quarantined at 33 or elect to have the quarantined e-mail deleted after a predetermined period of time has elapsed.

If an employee user is sent an e-mail message and the e-mail is free of any malicious content, malware, spam and viruses, the e-mail is scanned for any policy violations from the compliance server 36. If the e-mail message violates a policy established in reference libraries 38 the e-mail message is quarantined at 33. A business owner or manager user may check quarantine 33 to review any such e-mail messages or elect to have the quarantined e-mail deleted after a predetermined period of time has elapsed.

If an employee user sends an e-mail message to a recipient the e-mail message is scanned by compliance server 36 for any policy violations. If a policy established within libraries 38 is violated the e-mail is quarantined at 33. A business owner or manager user may check quarantine 33 to review any such e-mail messages or elect to have the quarantined e-mail deleted after a predetermined period of time has elapsed.

### D. Behavior and Anti-Grooming Security

If an employee user desires to use computer 13 to connect to ISP 18, the employee user will launch a web browser computer program on the computer. In response, thin client 12 and web proxies 14 direct the employee user to authentication server 22 via firewalls 20, and a successful login is accomplished. The employer may choose to have a SSL/VPN connection established for employers to meet certain regulations. The employee user will see his or her browser “home page” appear, the home page being set by the employee user in the browser's settings. If the employee user does not violate any policy or malicious content and no malware, spam, Trojans or viruses are found the behavioral and anti-grooming server 46 monitors for any grooming or translation behavior from any recipient or initialized communication.

### E. Business Subscriber Administration Portal

Detected policy violations, threats, malicious content and objectionable behavior may be logged and categorized at 29 for a business owner or manager user to view the internet activity the employee user has experienced. This activity may be viewed through subscriber administration portal 28. Reports containing the information logged at 29 may also be e-mailed to a predetermined e-mail account specified by a business owner or manager user.

While this invention has been shown and described with respect to a detailed embodiment thereof, it will be understood by those skilled in the art that changes in form and detail thereof may be made without departing from the scope of the claims of the invention.

What is claimed is:

1. A system for preventing the reception and transmission of malicious or objectionable content transmitted through a network, comprising:
a thin client installed upon a user computer and associated with a web browser computer program installed upon the user computer, the thin client and web browser being coupled to a web proxy server with a network service provider;
at least one protective server intermediate the web proxy server and the network, the protective server being dedicated to detecting a type of malicious or objectionable content and acting to deter the reception of detected content by the user computer; and
at least one reference library containing a profile defining malicious or objectionable content, the protective server utilizing the library to identify the malicious or objectionable content.

2. The system of claim 1, further comprising a firewall intermediate the web proxy server and the protective server.

3. The system of claim 2, further comprising a global reputation service configured to rank network traffic in terms of a predetermined threat.

4. A method for preventing the reception and transmission of malicious or objectionable content transmitted through a network, comprising the steps of:
installing a thin client upon a user computer and associating the thin client with a web browser computer program installed upon the user computer;
coupling the thin client and web browser to a web proxy server with a network service provider;
installing at least one protective server intermediate the web proxy server and the network, the protective server being dedicated to detecting a type of malicious or objectionable content and acting to deter the reception of detected content by the user computer; and
providing at least one reference library containing a profile defining malicious or objectionable content, the protective server utilizing the library to identify the malicious or objectionable content.
